(19) United States
(12) Patent Application Publication
(10) Pub. No.: US 2010/0006663 A1
(43) Pub. Date: Jan. 14, 2010

(54) PROCESS AND DEVICE FOR PRODUCING A FINELY DISTRIBUTED FUEL MIST

(75) Inventors: Mirko Linscheidt, Burg Stargard (DE); Harald Miethe, Neubrandenburg (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: Webasto AG, Stockdorf (DE)

(21) Appl. No.: 11/719,431

(22) PCT Filed: Oct. 20, 2005
(86) PCT No.: PCT/DE2005/001881

§ 371 Date: Mar. 3, 2009

(30) Foreign Application Priority Data
Nov. 16, 2004 (DE) 10 2004 055 326.2

(51) Int. Cl. B60H 1/22; B05B 17/04

(52) U.S. Cl. 237/12.3 C; 239/4; 239/102.1

(57) ABSTRACT

A process and a device for producing a finely distributed fuel mist, especially for preparing an easily burnable fuel-air mixture for the heater (25) of a motor vehicle. In a chamber (1) which is partially filled with a fuel (3), an ultrasonic oscillator (2) is immersed in the liquid fuel (3) and a fuel column with an exposed fuel surface (4) is formed above the ultrasonic oscillator (2). The ultrasonic oscillator (2) is operated with a frequency such that extremely small fuel particles (5) are detached at the surface (4) of the and a fuel mist is formed in the chamber (1). In a heater, the device in located in an air flow stream which creates a negative pressure that draws the fuel mist out of the chamber opening (6).

### BACKGROUND OF THE INVENTION

1. Field of the Invention

The invention relates to a process and a device for producing a finely distributed fuel mist, especially for preparing an easily burnable fuel-air mixture for the heater of a motor vehicle.

2. Description of Related Art

Numerous processes and devices for atomization of liquids are known which, based on various physical action principles, cause atomization of a liquid, especially of a fuel, into small liquid particles for a large number of applications. In heaters, especially independent vehicle heaters of motor vehicles, good fuel induction for ignition and combustion of the fuel-air mixture is especially important because, of course, it dictates the serviceability of the heater. The prior art discloses, for example, atomization systems which, with a high pressure-capable atomizer nozzle, produce a fuel-air mixture which is described, for example, in German Patent Application DE 102 07 311 A1 and corresponding to U.S. Pat. No. 6,764,302. One of the disadvantages of these devices is that the atomizer nozzle can be clogged, for example, by dirt particles, as a result of which production of a finely distributed fuel-air mixture is no longer ensured. Furthermore, these atomizers have the disadvantage that the fuel must be pressed though the nozzle with a high pressure in order to achieve satisfactory fuel-air atomization, which is also called a fuel-air aerosol.

In German Patent Application DE 35 24 701 A1, a fuel-air aerosol is achieved by means of an ultrasonic atomizer nozzle. This nozzle has an atomizer housing with several injection openings in its front side, which lead from a pressure space in the interior of the atomizer housing to the outside. The fuel which is under pressure in the pressure space of the ultrasonic atomizer nozzle emerges via injection openings as a fine fuel jet and is excited to break down into fuel droplets by an ultrasonic oscillator which is placed in the ultrasonic atomizer nozzle, yielding a fuel-air mixture. One of the disadvantages of this device is that the injection openings can clog so that the required throughput of the fuel-air mixture cannot be achieved.

German Patent Application DE 39 42 747 A1 describes an ultrasonic atomizer in a motor vehicle heater. The ultrasonic atomizer has an ultrasonic oscillator, a rod which projects from the latter, and an atomizer plate on the end of the rod. The fuel is supplied to the atomizer plate by a fuel line through an internal channel which extends through the projecting rod. In German Patent Application DE 39 33 300 A1, an ultrasonic atomizer with an ultrasonic oscillator is described which has an essentially axially symmetrical metal body. In this connection, the ultrasonic oscillator is made with an oblong region which is provided with an atomizer plate on its free end. The oblong region is made with an axial passage by which liquid fuel is applied from a fuel reservoir to the outside surface of the atomizer plate. In these two devices, the fuel is atomized by ultrasound, by which a fuel-air aerosol forms via formation of capillary waves on the surface of the fuel which has been applied to the atomizer plate as a film. One of the disadvantages of these devices is that the ultrasonic atomizer—especially the ultrasonic oscillator—is provided with channels for fuel supply, by which the production cost for such a component is increased. Another disadvantage is that the fuel supply which pulses through the pump interval must be damped with complex means.

### SUMMARY OF THE INVENTION

The object of the invention is to devise a device and a process for producing a finely distributed fuel mist, the aforementioned disadvantages being avoided, especially a fuel mist being produced with which an improved combustion process can be achieved. The object is achieved by a process in which an ultrasonic oscillator is immersed in fuel in a chamber which is partially filled with a liquid fuel in a manner forming a fuel column with an exposed fuel surface above the ultrasonic oscillator and the ultrasonic oscillator is operated at a frequency such that extremely small fuel particles are detached on the surface of the fuel and a fuel mist is formed in the chamber.

In the accordance with invention, the ultrasonic oscillator is preferably provided with electrical connections so that electrical excitation energy can be supplied. In this connection, the ultrasonic oscillator is set into mechanical oscillations during operation. In accordance with the invention, the ultrasonic oscillator is excited with a frequency which is in the megahertz range. In this way, the ultrasonic oscillator produces ultrasonic oscillations which are routed by the liquid fuel, which can be, for example, gasoline, diesel fuel or kerosene, to the fuel surface, therefore to the fuel-air interface.

The continuous compression and decompression of the fuel column above the ultrasonic oscillator causes acoustic energy in the immediate vicinity of the fuel surface. In this way, crossed capillary waves form from which extremely small mist droplets (=aerosol) are detached at the wave peak. By this process, fuel can be thrown high above the fuel surface, so that a finely distributed, homogenous fuel mist forms which can be routed, for example, via an outlet opening out of the chamber. It is especially advantageous that the process in accordance with the invention can produce a large volumetric flow of the finely distributed fuel mist, and at the same time, very small fuel droplets are attainable, which is very advantageous for the combustion process.

In one preferred alternative, outside the chamber which is formed with an outlet opening, an air flow which allows an underpressure to form in the chamber flows so that the fuel mist leaves the chamber through the outlet opening and is mixed with the air flow to form a fuel-air mixture. Within the chamber, a fuel mist forms with a very large concentration of fuel particles. Outside the chamber, reliable intermixing of the preferably rotating air flow with the emerging fuel mist occurs so that the resulting fuel-air mixture outside the chamber is suited for a combustion process, for example, in the heater of a motor vehicle.

So that a satisfactory fuel mist is produced in the chamber, it is important that a relatively high fuel column is present in the ultrasonic oscillator. It has been found that at a height of the fuel column h in the range of 15 mm≧h≧50 mm, preferably in the range of 20 mm≧h≧40 mm, a very finely distributed and homogeneous fuel mist can be achieved. To ensure this, during operation, at the same time, the chamber is refilled with fuel via a fuel supply so that the fuel column height h is within the aforementioned ranges during operation. In one embodiment of the invention, there can be means—preferably sensors—which measure the fuel column height h in the chamber. The sensors can be connected to an evaluation unit which controls the amount of fuel supply into the chamber. The sensors and evaluation unit can be in direct contact, for example, by a wireless connection which can be a radio link in one embodiment. The radio link is preferably in the GHz range according to the Bluetooth® standard.

In one preferred embodiment of the process, during operation the fuel column height h is kept essentially constant. It has been found that at a constant fuel column height h the quality of the fuel mist to be produced, especially with respect to fuel droplet size and to uniform distribution of the fuel particles, is beneficial.

The invention likewise relates to a device for producing a finely distributed fuel mist in which an ultrasonic oscillator is located on the bottom region of a chamber which has a fuel supply which is spaced apart from the ultrasonic oscillator, by which the liquid fuel can be delivered into the chamber which is made with a closable outlet opening. The device is made, in accordance with the invention, such that there is a relatively high fuel column above the ultrasonic oscillator during operation. In contrast to the ultrasonic oscillators which are known in the prior art and which are wetted with a thin film of fuel, the fuel mist forming only directly on the ultrasonic oscillator, in the device in accordance with the invention, the fuel particles, for the most part, are detached on the fuel surface, by which larger detachment rates can be achieved. Furthermore, the device has greater resistance to impurities in the fuel. An increase of the detachment rate on the fuel surface can be caused, for example, by an ultrasonic oscillator with a larger area. One of the other advantages of this device is that ultrasonic oscillators can be used which have a simple configuration and which can be mounted in the device and dismounted from the device without major effort by the worker.

In one preferred embodiment, the ultrasonic oscillator is executed as a piezoceramic component which is, for example, disk-shaped. The ultrasonic oscillator is connected to an electronic control device which, depending on various operating characteristics, triggers the ultrasonic oscillator.

Advantageously, the ultrasonic oscillator is located on a bearing unit which can be made, for example, as an elastic rubber sleeve, attached to the bottom region of the chamber. The elastic rubber sleeve makes it possible for the ultrasonic oscillator to be set into mechanical oscillations during operation, at the same time, the sleeve assuming a sealing function relative to the fuel. Advantageously, the sleeve is made from a fuel-resistant material.

In another alternative of the invention, the chamber can have a base element and a cover element which at least partially surrounds the base element and which is made with an outlet opening. Advantageously, the chamber is made essentially cylindrical, the cover element being supported on the outer side on the base element to be able to move axially. The cover element can be moved back and forth along the base element via a drive unit. The drive unit can be, for example, a solenoid valve, a motor actuator or a lifting magnet, the drive unit being made as a linear drive. Depending on the position of the cover element, a closed position or an open position of the chamber can be achieved. The base element is advantageously made of a stainless steel, the cover element, conversely, can be made of a temperature-resistant plastic. In another embodiment of the invention, the cover element can be pivotally supported on the base element. In this case, it is advantageous to make the drive unit as a rotary drive.

Preferably, there is a seal on the side opposite the bottom region of the chamber. The seal can be a ring seal which is attached to the underside, that is, to the closed front side of the cover element. In the closed position, the seal makes contact with the base element, at the same time, the outlet opening is covered and sealed by at least one region of the jacket surface of the base element being engaged by the seal. In the open position of the outlet opening, the seal is spaced at a distance from the base element.

In another possible embodiment, the device can have means which apply a force to the cover element in the closed position in the direction toward the bottom region of the chamber. In the non-operating state, it is ensured that fuel cannot flow out of the outlet opening. In order to reliably keep the closure element in the closed position, a tension force can be produced on the cover element, for example, via a spring, by which a good sealing action is achieved. Likewise, it is possible that solely the drive unit applies a force which keeps the cover element in the closed position.

Other advantages, features and details of the invention will become apparent from the following description in which one embodiment of the invention is described in particular with reference to the drawings.

### BRIEF DESCRIPTION OF THE DRAWINGS

FIG. 1 is a sectional view of the device in accordance with the invention for producing a fuel mist in the closed position,

FIG. 2 is a sectional view of the device in accordance with the invention for producing a fuel mist in the open position,

FIG. 3 is a perspective side view of the device shown in FIG. 1,

FIG. 4 is a perspective side view of the device as shown in FIG. 2, and

FIG. 5 is a sectional view of an air heater of a motor vehicle equipped with the fuel mist producing device in accordance with the invention.

### DETAILED DESCRIPTION OF THE INVENTION

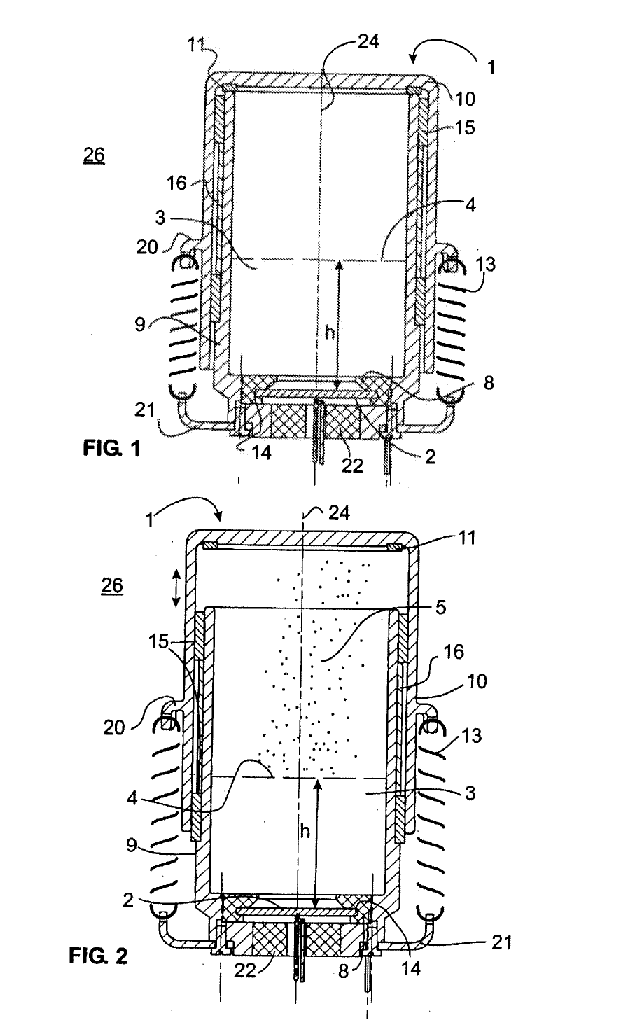

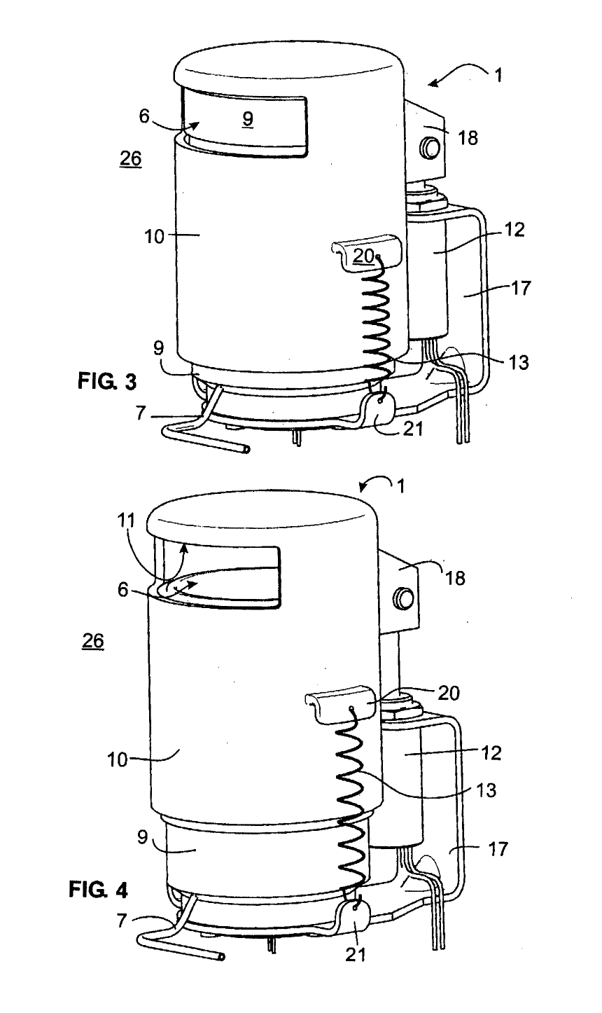

FIGS. 1 and 2 show a cylindrical chamber 1 for a heater of a motor vehicle. On the bottom region of the chamber 1, there is an ultrasonic oscillator 2 which is immersed in the liquid fuel 3. As can be seen especially in FIGS. 1 & 2, a fuel column having a height h forms above the ultrasonic oscillator 2 and has an exposed fuel surface 4. Within the chamber 1 is the discharge region of a fuel supply 7 which is shown in FIGS. 3 & 4 and which is positioned at a distance to the ultrasonic oscillator 2. The fuel 3 is conveyed into the chamber 1 via a pump (not shown). In this connection, pulsating fuel supply does not disrupt the process.

On the side of the chamber 1 opposite the ultrasonic oscillator 2, there is a sealable outlet opening 6 (see, FIGS. 3 & 4). The ultrasonic oscillator 2 is a piezoceramic, disk-shaped component which is supported by form-fit in the rubber sleeve 8 shown in FIGS. 1 & 2. On the inside of the rubber sleeve 8, a groove 14 is formed in which the ultrasonic oscillator 2 is reliably held. The rubber sleeve 8 is impressed in the bottom region of the chamber 1. It is especially advantageous that the ultrasonic oscillator 2 can be mounted in the rubber sleeve 8 and/or dismounted from the rubber sleeve 8 without major effort. The chamber 1 has a base element 9 and a cover element 10 which at least partially surrounds the base element 9 and in which the outlet opening 6 is located. As FIGS. 3 & 4 illustrate, the outlet opening 6 is rectangular. Of course, the opening 6 can have other geometrical shapes.

The cover element 10 has a larger diameter than the base element 9 and is slipped on over the base element 9 in the manner of a sleeve. Two bearing sleeves 15 are locked in the direction of the cylinder axis 24 by means of a spacer sleeve 16 made, preferably, of stainless steel so as to be attached on the jacket surface of the base element 9. The cover element 10 thus adjoins the bearing sleeves 15 and can be moved in the axial direction with respect to the cylinder axis 24 which is illustrated by the double arrow shown in FIG. 2. The bearing sleeves 15 are made from a plastic bearing material.

By moving the cover element 10 in the axial direction, the device in accordance with the invention can be moved into a closed position and an open position. Linear movement of the cover element 10 takes place via a drive unit 12 which is a lifting magnet 12 in the illustrated embodiment. The lifting magnet 12, which is attached to a holding angle 18, is dynamically connected to the cover element 10. In this regard, the cover element 10 has a connecting element 18 to which the lifting magnet 12 is attached. The holding angle 17 is connected securely to the base element 9 in the bottom region of the chamber 1.

On the outside of the chamber 1, a tension spring 13 is connected to the cover element 10 and the holding angle 17 via two angle elements 20, 21. In this embodiment, the angle elements 20 and 21 are connected in one piece to the cover element 10 and the holding angle 17 respectively. The angle elements 20, 21 can also be attached positively and/or nonpositively and/or by a material connection to the cover element 10 and/or to the holding angle 17.

On the underside of the cover element 10, i.e., on the side facing the ultrasonic oscillator 2, a ring seal 11 is attached. Underneath the ultrasonic oscillator 2, an elastomer sleeve 22 is positioned which acts as a bottom seal for the chamber 1 and as a cable guide for the ultrasonic oscillator 2.

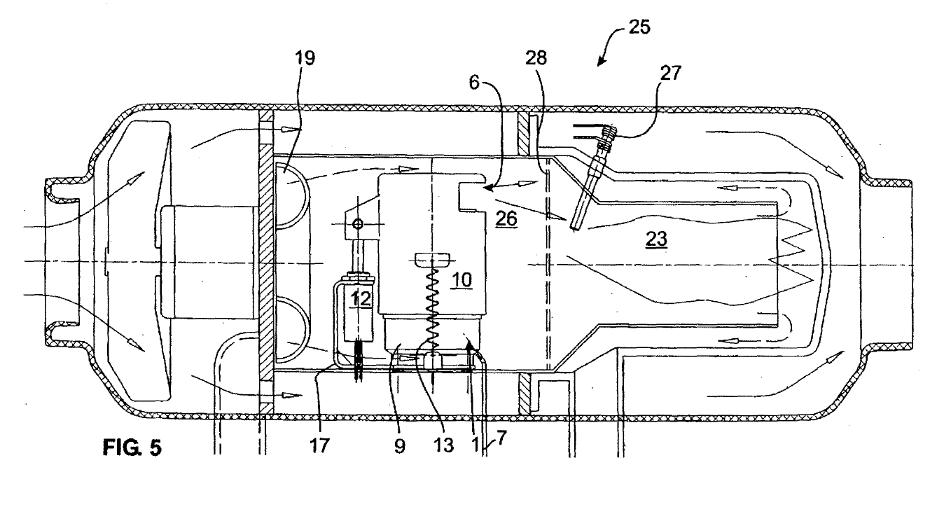

During operation, the ultrasonic oscillator 2 is excited with a frequency of roughly 1.7 MHz, by which ultrasonic oscillations are produced that are routed through the fuel 3 to the fuel surface 4. During the negative pressure phase, the ultrasonic wave ruptures the fuel 3 at the surface 4 and cavities form which collapse in the following pressure phase. Extremely small fuel particles 5 are formed so that a fuel mist forms above the fuel surface 4 in the chamber 1 in an extremely short time. The resulting fuel mist can travel into the mixing space 26 of the heater 25 when the outlet opening 6 is in the open position (see, FIGS. 2, 4 & 5) in which the seal 11 does not adjoin the base element 9. So that the fuel mist can reliably leave the chamber, the air flow streaming outside the chamber 1 (indicated by the arrows in FIG. 5) causes a negative pressure in the chamber 1, so that the fuel mist leaves the chamber 1 through the outlet opening 6 and is mixed with the air flow as a fuel-air mixture. As FIG. 5 illustrates, a rotating air flow is produced and routed past the chamber 1 via a combustion air fan 19.

Reliable mixing of the air flow with the fuel mist to form an easily combustible fuel-air mixture takes place in the mixing space 26 between the outlet opening 6 and an ignition element 27 which is located in the heater 25. Between the mixing space 26 and the ignition element 27 a heat shield 28 is positioned which acts both as a mixture passage controller and also to catch possible flame blowback. With the ignition element 27, the fuel-air mixture is ignited so that a stable, open flame bums in the combustion space 23 of the burner of the heater which is located downstream of the heat shield 28.

In order to achieve a satisfactory atomization of the fuel 3, it is important for the fuel column height h to be high enough within the chamber 1 during operation. In this embodiment, the fuel column height h is roughly 30 mm; likewise, its is of major importance for the space available for the fuel mist above the fuel surface 4 to have a large enough volume. The ultrasonic oscillator 2 has a diameter of roughly 25 mm which with an excited frequency of 1.7 MHz and delivers an atomization power of roughly 6.7 ml per minute. While a certain amount of fuel is leaving the chamber 1, at the same time, the amount of fuel consumed is made up uniformly via the fuel supply 7, by which the fuel column height h is kept essentially constant.

If combustion operation of the heater 25 is to be terminated, the electrical excitation of the ultrasonic oscillator 2 and fuel supply are turned off. At the same time, or with a defined time delay, the lifting magnet 12 is turned off, so that the cover element 10 is moved into the closed position. In this connection, the cover element 10 is moved axially along the base element 9 in the direction toward the bottom region of the chamber 1. In the closed position, which is shown in FIGS. 1 & 3, the ring seal 11 directly adjoins the base element 9, the outlet opening 6 being completely covered by the jacket surface of the base element 9. In the closed position, fuel 3 cannot emerge. The tension springs 13 located outside the chamber 1 apply a force to the cover element 10 in the direction toward the bottom region of the chamber 1 so that the ring seal 11 rests securely against the upper, front-side edge of the base element 9 and produces a reliable sealing action. The combustion air fan 19 is turned off a few seconds after completion of combustion operation.

In an alternative embodiment of the invention (not shown), the springs 13 can also be located within the chamber 1. The springs 13 can likewise be omitted when the drive unit 12 can apply a large enough resetting force. In this configuration, the sealing action between the base element 9 and the cover element 10 including the seal 11 is implemented solely by the resetting force of the drive unit 12. These construction measures can minimize the dimensions of the chamber 1 which can likewise be made structurally simpler.

Furthermore, it is possible, instead of a linear drive, to use a rotary drive for closing and opening the outlet opening. A combination of a rotary drive with a pivoting piston which can move the chamber 1 around the axis of rotation is likewise possible. So that during operation of the device in accordance with the invention, the fuel 3 cannot flow out of the outlet opening 6 due to any cornering, acceleration or deceleration processes, it can be a good idea to provide “anti-sloshing protection”. In this connection, there can be sheets located on the inside wall of the chamber 1 above the fuel surface 4, by which the fuel 3 can be stilled.

To improve the atomization effect within the chamber 1, in another embodiment of the invention (not shown), the ultrasonic oscillator 2 can be easily positioned in an oblique position against the outlet opening 6. This means that the cylinder axis 24 does not run perpendicular to the disk-shaped ultrasonic oscillator 2. The purpose of this is to intake only the fuel particles 5 with the smallest diameter from the outlet opening 6. Somewhat larger fuel particles 5 strike the inside chamber wall which faces away from the outlet opening 6 and on which they settle and flow back in the direction of the bottom region of the chamber 1.

What is claimed is:

1-21. (canceled)

22. Process for producing a finely distributed fuel mist for the heater of a motor vehicle, comprising the steps of:
immersing an ultrasonic oscillator in fuel in a chamber which is partially filled with a liquid fuel in a manner forming a fuel column with an exposed fuel surface above the ultrasonic oscillator and
operating the ultrasonic oscillator with a frequency such that extremely small fuel particles are detached on the surface of the fuel and a fuel mist is formed in the chamber.

23. Process as claimed in claim 22, wherein the ultrasonic oscillator is excited with a frequency which is in the megahertz range.

24. Process as claimed in claim 22, wherein the chamber is made with an outlet opening and wherein an air flow is produced outside of the chamber which causes a negative pressure to form in the chamber so that the fuel mist leaves the chamber through the outlet opening and mixes with the air flow.

25. Process as claimed in claim 22, wherein fuel is fed into the chamber via a fuel supply.

26. Process as claimed in claim 25, wherein a sensor measures the height of the fuel column.

27. Process as claimed in claim 26, wherein the height of the fuel column is kept substantial constant during operation by the action of said sensor and fuel supply.

28. Process as claimed in claim 27, wherein the height of the fuel column h is maintained in a range of 15 mm≧h≧50 mm during operation.

29. Process as claimed in claim 27, wherein the height of the fuel column h is maintained in the range of 20 mm≧h≧40 mm during operation.

30. Device for producing a finely distributed fuel mist for a heater of a motor vehicle, comprising:
a chamber with a sealable outlet opening;
a fuel supply by which the liquid fuel is delivered into the chamber;
an ultrasonic oscillator in a bottom region of the chamber spaced apart from the fuel supply,
wherein the device is made such that, during operation, a fuel column is located above the ultrasonic oscillator.

31. Device as claimed in claim 30, wherein the ultrasonic oscillator is a piezoceramic component.

32. Device as claimed in claim 30, wherein the ultrasonic oscillator is disk-shaped.

33. Device as claimed in claim 30, wherein the ultrasonic oscillator is attached to a bearing unit.

34. Device as claimed in claim 33, wherein the bearing unit is a rubber sleeve.

35. Device as claimed in claim 30, wherein the chamber has a base element with an outlet opening and a closure element which at least partially surrounds the base element.

36. Device as claimed in claim 35, wherein the chamber is essentially cylinder-shaped, and wherein the closure element is supported on the base element to be axially moveable.

37. Device as claimed in claim 36, wherein further comprising a seal on a side opposite the bottom region of the chamber.

38. Device as claimed in claim 37, wherein the seal is a ring seal which is attached to an underside of a closure element.

39. Device as claimed in claim 35, wherein a drive unit is dynamically connected to the closure element.

40. Device as claimed in claim 37, wherein a seal makes contact with at least one region of a jacket surface of the base element in a closed position of the chamber so as to completely close the outlet opening, and the seal being spaced at a distance from the base element with the outlet opening being opened in an open position.

41. Device as claimed in claim 40, further comprising means for applying a force to the closure element in a direction toward the bottom region of the chamber in the closed position.

42. Device as claimed in claim 30, further comprising sensor means for maintaining the height of the fuel column substantial constant during operation.

43. Heater for a motor vehicle with a device, comprising:
a fuel-fired burner; and
device for producing a finely distributed fuel mist and supplying it to said burner said device having:
a chamber with a sealable outlet opening fro which the fuel mist is supplied to said burner;
a fuel supply by which the liquid fuel is delivered into the chamber; and
an ultrasonic oscillator in a bottom region of the chamber spaced apart from the fuel supply,
wherein the device is made such that, during operation, a fuel column is located above the ultrasonic oscillator.

44. Device as claimed in claim 43, further comprising sensor means for maintaining the height of the fuel column substantial constant during operation.
